(19) United States
(12) Patent Application Publication
(10) Pub. No.: US 2026/0257312 A1
(43) Pub. Date: Sep. 3, 2026

(54) MACHINING CENTER FOR MACHINING AN ELONGATED METAL WORKPIECE

(71) Applicant: AFW Holding GmbH, Kirchham (AT)

(72) Inventor: Dominik WEINGÄRTNER, Kirchham (AT)

(21) Appl. No.: 19/474,567

(22) PCT Filed: Apr. 18, 2024
(86) PCT No.: PCT/EP2024/060567

§ 371 Date: Oct. 10, 2025

(30) Foreign Application Priority Data
Apr. 21, 2023 (EP) 23169320.1

(51) Int. Cl. B23Q 39/02; B23C 3/00; B23Q 15/007; B23Q 39/00

(52) U.S. Cl. CPC B23Q 39/023; B23C 3/002; B23Q 15/007; B23Q 39/026; B23Q 2039/008; B23Q 2240/007

(57) ABSTRACT

A machining center for machining an elongated metallic workpiece, including a mounting device for mounting an elongated metallic workpiece to be machined, a first milling unit movable in at least one degree of freedom relative to a workpiece supported by the mounting device, and a second milling unit movable in at least one degree of freedom relative to a workpiece supported by the mounting device. The machine center further includes a control device which is configured for controlling movements of the first milling unit in the at least one degree of freedom of movement in or within a first machining area of the workpiece assigned to the first milling unit, and for controlling movements of the second milling unit in the at least one degree of freedom of movement in or within a second machining area of the workpiece.

This application is the U.S. National Stage entry of International Application No. PCT/EP2024/060567, filed on Apr. 18, 2024, which, in turn, claims priority to EP Patent Application No. 23169320.1, filed on Apr. 21, 2023, both of which are hereby incorporated herein by reference in their entireties for all purposes.

The invention relates to a machining center for machining an elongated metallic workpiece, in particular for manufacturing a drive element, especially for a drill string, comprising a mounting device for mounting an elongated metallic workpiece to be machined.

Machining centers for machining an elongated metallic workpiece, in particular for manufacturing a drive element, in particular for a drill string, are generally known from the prior art in various embodiments and to date typically comprise a milling unit movable in at least one degree of freedom relative to a workpiece supported by the mounting device, by means of which the machining of the elongated metallic workpiece is carried out.

Such workpieces can have lengths of more than 5 m, which poses challenges for the efficiency of machining.

Although known machining centers enable reliable machining of such elongated metallic workpieces, they regularly require improvement or further development in terms of their efficiency or machining speed.

There is therefore a need for a machining center that enables reliable machining of an elongated metallic workpiece with improved efficiency and machining speed.

Against this background, the object of the invention is that of providing an improved machining center for machining elongated metallic workpieces, in particular for manufacturing a drive element, especially for a drill string.

The object is achieved in particular by a machining center for machining an elongated metallic workpiece, in particular for manufacturing a drive element, in particular for a drill string, according to the independent claim. The subjects of the dependent claims relate to possible embodiments of the machining center according to independent claim 1.

A first aspect of the invention relates to a machining center for machining an elongated metallic workpiece. The machining center is therefore generally configured for machining an elongated metallic workpiece. The machining of an elongated metallic workpiece that can be performed by means of the machining center can be used in particular for the manufacture of a drive element, e.g., in the form of a rotor, in particular for a drill string. The machining center can therefore be configured in particular for machining an elongated metallic workpiece for the purpose of manufacturing a drive element, e.g., in the form of a rotor, in particular for a drill string. The workpiece can therefore have a cylindrical geometry or basic shape. When referring to a workpiece in the following, this means an elongated metallic workpiece that can be machined using the machining center.

The machining center comprises a mounting device for mounting a workpiece. The mounting device can be configured in particular for the rotary mounting of a workpiece; the mounting device can therefore be configured to bear a workpiece rotatably about its longitudinal axis, for which purpose the mounting device can comprise one or more drives by means of which a supported workpiece can be set in rotary motion about its longitudinal axis. The rotatable support of a workpiece enables complete machining of the outer circumference of the workpiece.

The mounting device may be formed by one or more mounting units or comprise one or more mounting units. Typically, the mounting device comprises a first mounting unit, which is configured for mounting a first section, in particular a first free end, of a workpiece, and a second mounting unit, which is configured for mounting a second section, in particular a second free end, of the workpiece. The respective mounting units may, for example, be designed as clamping and/or tensioning units or comprise such units, which are configured for clamping or tensioning a workpiece, i.e., in particular, the respective first and second sections of a workpiece. Specific examples of corresponding mounting units include, but are not limited to, chucks, tailstocks, etc. Regardless of their specific design, the respective mounting units can be mounted so that they can move relative to each other in one degree of freedom, e.g., translational, in particular along a machining or machine axis of the machining center. The mounting device can therefore be configured to bear workpieces of different lengths, as at least one mounting unit can be movably mounted relative to another mounting unit. The mounting device may comprise one or more drives for this purpose, via which at least one mounting unit can be moved relative to another mounting unit, in particular in a movement, especially along the machining or machine axis of the machining center. Specifically, respective mounting units can, for example, be movably arranged or formed on or in a machine bed of the machining center.

At this point, it should be noted in general that the mounting device can in principle be configured to store workpieces with a length of more than 5 m, in particular more than 7.5 m, and in particular more than 10 m. Accordingly, the machining center can be configured to machine workpieces with a length of more than 5 m, in particular more than 7.5 m, and in particular more than 10 m.

The machining center also comprises a first milling unit that can be moved relative to a workpiece stored by means of the mounting device in at least one degree of freedom, which can in principle be a translational and/or a rotational degree of freedom. The first milling unit typically comprises a housing structure, a milling tool arranged on or in the housing structure and rotatable about a tool axis, and a (motor) drive arranged on or in the housing structure and associated with the milling tool, which drive is configured to generate a driving force that sets the milling tool in rotational motion and to transmit this driving force to the milling tool. Specifically, the first milling unit can thus be designed, for example, as a milling head, which comprises a corresponding housing structure and at least one milling tool arranged on or in the housing structure.

The housing structure of the first milling unit can be arranged directly or indirectly on a support structure, e.g., of a slide-type, which can be moved translationally along the machining or machine axis of the machining center. The support structure can be configured to support the first milling unit or a corresponding milling head in at least one degree of freedom of swivel movement around a swivel axis oriented, for example, parallel or at right angles to the machining or machine axis of the machining center, and can comprise one or more drives for this purpose. The support structure may also comprise one or more support elements which are configured to support the workpiece. At least one support element may be moved towards the workpiece by means of one or more drives, e.g. radially with respect to the longitudinal axis of the workpiece, in order to support the workpiece in the area of the support structure and thus in the area of machining by the first milling unit. It is also conceivable that at least one corresponding support element is arranged or formed on the housing structure of the first milling unit and either the housing structure together with the at least one support element or only the at least one support element is mounted movably relative to the housing structure so that it can be moved against the workpiece in order to support the workpiece in the area of the support structure and thus in the area of machining by the first milling unit.

In order to move the first milling unit relative to a workpiece supported by the mounting device, the machining center comprises at least one (motor) drive assigned to the first milling unit, which drive is designed to generate a driving force that moves the first milling unit relative to a workpiece supported by the mounting device and to generate a driving force that moves the first milling unit relative to a workpiece supported by the mounting device. (motor) drive associated with the first milling unit, which is configured to generate a drive force that moves the first milling unit in a movement relative to a workpiece supported by the mounting device and to transmit this drive force to the first milling unit. The movement of the first milling unit is, in particular, a translational movement along a translational axis, which may coincide with or be arranged parallel to the machining or machine axis of the machining center. In addition, a translational movement of the first milling unit against the workpiece or a workpiece is possible.

In addition to the translational degree of freedom relative to a workpiece supported by the mounting device along the translational axis, the first milling unit can also be movably supported in at least one further degree of freedom relative to a workpiece supported by the mounting device. A further degree of freedom of movement of the first milling unit can, for example, be a degree of freedom of swivel movement about a swivel axis parallel and/or perpendicular to the machining or machine axis of the machining center. Consequently, the first milling unit can be movable in at least one degree of translational freedom and in at least one degree of freedom of swivel movement relative to a workpiece mounted by the mounting device. In this way, complex milling tasks can be performed by means of the first milling unit, and complex geometries can thus be introduced into the workpiece.

The machining center further comprises a second milling unit that is movable in at least one degree of freedom, which can basically be a translational and/or a rotational degree of freedom, relative to a workpiece or the workpiece supported by the mounting device. The second milling unit typically comprises a housing structure, a milling tool arranged on or in the housing structure and rotatable about a tool axis, and a (motor) drive arranged on or in the housing structure and associated with the milling tool, which is configured to generate a drive force that sets the milling tool in rotational motion and to transmit this drive force to the milling tool. Specifically, the second milling unit can also be designed, for example, as a milling head, which comprises a corresponding housing structure and at least one milling tool arranged on or in the housing structure.

A corresponding housing structure of the second milling unit can also be arranged directly or indirectly on a support structure, e.g., of a slide-type, which can be moved translatorily along the machining or machine axis of the machining center. The support structure can be configured to support the second milling unit or a corresponding milling head in at least one degree of freedom of swivel movement around a swivel axis oriented, for example, parallel or at right angles to the machining or machine axis of the machining center, and can comprise one or more drives for this purpose. The support structure may also comprise one or more support elements which are configured to support a workpiece. At least one support element may be moved against the workpiece for this purpose via one or more drives, e.g. radially with respect to the longitudinal axis of the workpiece, in order to support the workpiece in the area of the support structure and thus in the area of machining by the second milling unit. It is also conceivable that at least one corresponding support element is arranged or formed on the housing structure of the second milling unit and either the housing structure together with the at least one support element or only the at least one support element is mounted movably relative to the housing structure so that it can be moved against the workpiece in order to support the workpiece in the area of the support structure and thus in the area of machining by the first milling unit.

In order to move the second milling unit in a movement relative to a workpiece or the workpiece supported by the mounting device, the machining center comprises at least one (motor) drive assigned to the second milling unit, which drive is designed to generate a driving force that moves the second milling unit in a movement relative to a workpiece supported by the mounting device and to generate a driving force that moves the second milling unit in a movement relative to a workpiece supported by the mounting device. (motor) drive associated with the second milling unit, which is configured to generate a drive force that moves the second milling unit in a movement relative to a workpiece supported by the mounting device and to transmit this drive force to the second milling unit. The movement of the second milling unit is, in particular, a translational movement along a translational axis, which may coincide with or be arranged parallel to the machining or machine axis of the machining center. In addition, a translational movement of the second milling unit against the workpiece or a workpiece is possible.

In addition to the translational degree of freedom relative to a workpiece supported by the mounting device along the translational axis, the second milling unit can also be movably supported in at least one further degree of freedom relative to a workpiece supported by the mounting device. A further degree of freedom of movement of the second milling unit can, for example, be a degree of freedom of swivel movement about a swivel axis parallel and/or perpendicular to the machining or machine axis of the machining center. Consequently, the second milling unit can be movable in at least one degree of translational freedom and in at least one degree of rotational or degree of freedom of swivel movement relative to a workpiece supported by the mounting device. In this way, complex milling tasks can be performed by means of the second milling unit, and complex geometries can thus be introduced into the workpiece.

Typically, each milling unit is mounted so that it can move both in one degree of translational freedom along the machining or machine axis of the machining center and in one or more degrees of freedom of swivel movement around a swivel axis that is parallel and/or perpendicular to the machining or machine axis of the machining center. The translational movements and/or the swivel movements of the milling units are typically coordinated with or synchronized to a rotational movement of the workpiece about its longitudinal axis.

The machining center further comprises a hardware and/or software-implemented control device which is used to control movements of the first milling unit in the at least one degree of freedom in or within a first machining area assigned to the first milling unit of a the workpiece supported by the mounting device, and for controlling movements of the second milling unit in the at least one degree of freedom of movement in or within a second machining area assigned to the second milling unit of the workpiece supported by the mounting device. A respective machining area typically comprises at least one machining path determined by a starting point and an end point, within which the respective milling unit moves or can move during machining of the respective machining area. A respective machining area typically corresponds to an area or subarea of a workpiece which is to be machined by means of the machining center; The respective machining areas thus typically, common, represent the area of a respective workpiece to be machined by the machining center.

Each milling unit is or will typically be assigned at least one machining area, which the respective milling unit has to machined; The workpiece can thus be machined, in particular simultaneously, in different areas-these correspond to the machining areas of the respective milling units-by providing at least two milling units, which significantly increases the efficiency of the machining possible with the machining center compared to machining centers with only one milling unit.

The control device is typically also configured to define or generate respective machining areas and assign them to the milling units. The control device can therefore be configured to define a machining task for a workpiece by generating or defining and assigning machining areas in the sense of a machining job plan and, as will become apparent below, even to adapt it during operation of the machining center if necessary. Specifically, the control device can, for example, be configured to assign the first machining area of the workpiece to the first milling unit and to assign the second machining area of the workpiece to the second milling unit.

In this case, the control device can take one or more input parameters into account; consequently, the control device can be configured to generate respective machining areas on the basis of at least one input parameter and to assign them to the milling units. Corresponding input parameters can be, for example, and thus not exclusively: geometric-constructive parameters, such as dimensions, geometry, etc., of the workpiece to be machined, geometric-constructive parameters, such as dimensions, geometry, etc., of the machined workpiece, material parameters of the workpiece, such as hardness, machinability, etc., parameters of the milling units, such as power consumption, or parameters of the milling tools, such as type of milling tools, geometry of the milling tools, hardness of the milling tools, etc.

The control of movements of the first milling unit in or within the first machining area of the workpiece assigned to the first milling unit and the control of movements of the second milling unit in or within the second machining area of the workpiece assigned to the second milling unit, which is possible by means of the control device, may also include the control of one or more operating parameters, such as power consumption, the respective milling units for machining the workpiece in the respective machining area of the workpiece.

The control device may be assigned a user interface implemented in hardware and/or software, via which a user can make control-related inputs; in particular, it may be possible to use the user interface to make inputs regarding the planning and/or adjustment of machining jobs, on the basis of which the control device determines a machining task for a workpiece by correspondingly generating or defining and assigning machining areas in the sense of machining job planning and, if necessary, even adjusts it during operation of the machining center.

Overall, this provides an improved machining center for machining a workpiece.

The control device can be configured to control movements of the first milling unit in the at least one degree of freedom depending on or independently of movements of the second milling unit in the at least one degree of freedom, or vice versa. Consequently, movements of the first milling unit in the at least one degree of freedom can be controlled depending on and thus taking into account movements of the second milling unit in the at least one degree of freedom (or vice versa); this ensures, for example, that the milling units operate at a desired distance from each other in order to avoid situations in which the machining of a workpiece by means of the first milling unit in the first machining area may have a negative effect on the machining of the workpiece in the second machining area (or vice versa). A variant that is easier to implement in terms of control technology may be one in which movements of the first milling unit in the at least one degree of freedom are controlled independently of movements of the second milling unit in the at least one degree of freedom, meaning that the respective milling units operate independently of each other within their respective machining areas.

As mentioned, the control device can be configured to assign the first machining area of the workpiece to the first milling unit and the second machining area of the workpiece to the second milling unit. This can also include the control device being configured to assign the machining, i.e., in particular, the complete machining of the first machining area of the workpiece assigned to the first milling unit by means of the first milling unit and the machining, i.e., in particular, the complete machining of the second machining area of the workpiece assigned to the second milling unit by means of the second milling unit.

As also mentioned, a respective machining area typically comprises at least one machining path determined by a starting point and an end point. A respective starting or end point may, for example, be located at or in a peripheral edge area with respect to the longitudinal axis of the workpiece or within the workpiece. Consequently, the machining of a workpiece may, for example, be carried out with the first milling unit starting from a first peripheral edge area of the workpiece, such as a first free end of the workpiece; the first milling unit can then be moved during the machining of the workpiece, for example, starting from the edge area that has the starting point of the first machining area in the direction of the end point. The end point of the first machining area can then be offset in the direction of the second free end of the workpiece (“machining from the outside to the inside”). However, a reverse procedure (“machining from the inside out”) is also possible. Similarly, the workpiece can be machined with the second milling unit starting from a second edge area of the workpiece, such as a second free end of the workpiece; the second milling unit can therefore be moved during machining of the workpiece, e.g., starting from the edge area with the starting point of the second machining area in the direction of the end point. The end point of the second machining area can therefore be offset in the direction of the first free end of the workpiece (“machining from the outside to the inside”). Here, too, a reverse procedure (“machining from the inside out”) is possible.

Alternatively or additionally, a starting or end point of at least one machining area may be spaced apart from an edge area with respect to the longitudinal axis of the workpiece or within the workpiece. Consequently, variants are also conceivable in which a milling unit (only) machines the edge areas of a workpiece, e.g. in order to form certain interfaces in these, and another milling unit machines the remaining (inner) areas of the workpiece, e.g. in order to form a functional geometry in these that is necessary for the intended function of the machined workpiece.

Variants are also conceivable in which at least one milling unit is assigned several separate machining areas. The control device can therefore be configured to assign several separate machining areas to at least one milling unit.

In principle, the first and second machining areas may overlap each other at least in sections (axially with respect to the longitudinal axis of the workpiece) or may not overlap each other. In the first variant, the start and/or end point of the first machining area can therefore lie within the second machining area (or vice versa), resulting in an overlapping area in which machining of the workpiece by both milling units is possible. This can be useful, for example, when an (unmachined) workpiece is initially machined; initial machining of the workpiece in an area that can be designated as the initial area can therefore only be performed by one milling unit, whereupon the other milling unit begins machining the workpiece at or in the area that was initially machined (initial area). The machining areas assigned to the respective milling units can therefore overlap at least in an area of the workpiece comprising a corresponding initial area. In the second variant, the starting and/or end point of the first machining area lies outside the second machining area (or vice versa), so that no or fewer control-related measures, i.e., in particular safety-related measures, need to be provided in order to avoid, for example, undesirable proximity or collision of the milling units.

It has already been indicated that the control device can be configured to adjust or change the first and/or second machining area. Consequently, the machining area (originally) assigned to a respective milling unit can be changed, i.e., in particular enlarged or reduced; The machining area (originally) assigned to at least one milling unit can thus be enlarged or reduced by the control device. The control device can thus be configured to change the assignment of the first milling unit to the first machining area so that the first milling unit can also be assigned or is assigned to the second machining area, at least in sections. Alternatively or additionally, the control device can be configured to change the assignment of the second milling unit to the second machining area so that the second milling unit can also be assigned or is assigned to the first machining area, at least in sections.

The adjustment or change of a respective machining area can be carried out dynamically in particular. The adjustment or modification of a respective machining area can be carried out in particular during the machining of a workpiece, i.e. during the operation of the milling units.

The adjustment or modification of a respective machining area opens up a high degree of flexibility in connection with the machining of a workpiece, for example because it creates the possibility for a milling unit to (also) work in at least one of these areas of the workpiece that were not originally assigned. In this way, for example, machining delays of the other milling unit can be considered. The possibility of adjusting the first and/or second machining area can therefore also have a positive effect on the efficiency of the machining center.

The machining center may comprise a monitoring device which is configured to monitor the operation of the first milling unit and/or second milling unit and to generate monitoring information describing the operation of the first milling unit and/or the second milling unit. Monitoring the operation of the first milling unit and/or the second milling unit may also include monitoring the machining result and/or progress of the respective milling unit and generating information describing the respective machining result and/or the respective machining progress; this information may be included in the monitoring information.

The monitoring device may, for example, be designed as an optical monitoring device, such as an image or video recording device, or at least comprise such a device. Alternatively or additionally, other monitoring devices, such as acoustic monitoring devices, are equally conceivable since information about the operation of the first and/or second milling unit can also be derived from monitored acoustic signals.

The control device may be configured to adjust or change a respective machining area and/or the assignment of respective machining areas on the basis of the monitoring information. Consequently, an adjustment or change of respective machining areas can be made considering the operation of respective milling units or the machining result and/or progress of respective milling units, which can lead to highly efficient machining of a workpiece.

As mentioned, the milling units are typically movable relative to the workpiece in at least one degree of translational freedom. The movement of respective milling units in the translational degree of freedom relative to the workpiece can be realized via at least one guide device, in particular at least one linear guide device. The at least one guide device can extend along the machining or machine axis of the machining center. The at least one guide device may comprise one or more guide elements, in particular linear guide elements, such as guide rails, which are configured to interact with the respective milling unit to form a translationally movable guide. In particular, corresponding guide elements may be configured to interact with a corresponding counter-guide element on the part of a respective milling unit, e.g., mechanically, i.e., in particular, in a form-fitting and/or force-fitting manner. If a milling unit, as described above, is arranged on one of these associated support structures, e.g., of a slide-type, corresponding guide elements can be configured to interact with a corresponding counter-guide element of a respective support structure, e.g., mechanically, i.e., in particular by form and/or force fit.

It is conceivable that the first milling unit and the second milling unit are guided together via a common guide device, which can simplify the design of the machining center, as only one (single) guide device is required. Alternatively, it is conceivable that each milling unit is guided via its own guide device.

The machining center may also comprise a support device which is configured to support a workpiece to be machined by means of the machining center at one or more support points along the longitudinal axis. In this way, undesirable sagging of the workpiece can be avoided or at least reduced, which could otherwise have a negative effect on the machining of the workpiece by the milling units. The support device may comprise one or more support elements, each of which is movably mounted between at least one operating position, in which a workpiece to be machined by means of the machining center can be supported at a support point, and at least one non-operating position, in which support of a workpiece to be machined by means of the machining center at one or more support points is not possible.

In all embodiments, the first and second milling units may be identical in design; this ensures that milling tasks that are (or can be) performed with the first milling unit do not differ from milling tasks that are (or can be) performed with the second milling unit (and vice versa). However, it is also conceivable that the first and second milling units are not identical, so that milling tasks that are (or can be) performed with the first milling unit differ from milling tasks that are (or can be) performed with the second milling unit (and vice versa). For example, the first milling unit may enable machining with a geometrically undefined cutting edge and the second milling unit may enable machining with a geometrically defined cutting edge. More specifically, the first milling unit may, for example, enable rough machining of the workpiece and the second milling unit may not enable rough machining, but rather, for example, finish machining.

Furthermore, for all embodiments, individual, several, or all of the aforementioned functional units of the machining center, i.e., in particular the mounting device with the respective mounting units (if present), the milling units, the monitoring device (if present), the guide device (if present), the support device (if present), may be arranged or formed in a machine housing of the machining center forming a superordinate housing structure. The aforementioned machine bed of the machining center may also be arranged or formed in the machine housing of the machining center.

A second aspect of the invention relates to a method for machining an elongated metallic workpiece, in particular for manufacturing a drive element, in particular for a drill string. The method comprises in particular the following steps: supporting an elongated metallic workpiece to be machined by means of the machining center, moving a first milling unit in at least one degree of freedom relative to the supported workpiece, wherein the workpiece is machined with the first milling unit in at least one first machining area assigned to the first milling unit, moving a second milling unit in at least one degree of freedom relative to the supported workpiece, wherein the workpiece is machined with the second milling unit at least in a second machining area assigned to the second milling unit. The method further comprises the steps of: controlling movements of the first milling unit in the at least one degree of freedom of movement in or within the first machining area of the workpiece assigned to the first milling unit, and controlling movements of the second milling unit in the at least one degree of freedom of movement in or within the second machining area of the workpiece assigned to the second milling unit.

The method can be performed with a machining center according to the first aspect of the invention, so that all embodiments related to the machining center according to the first aspect of the invention apply analogously to the method according to the second aspect of the invention (and vice versa).

The invention is explained again below with reference to the embodiments shown in the figures. The figures show:

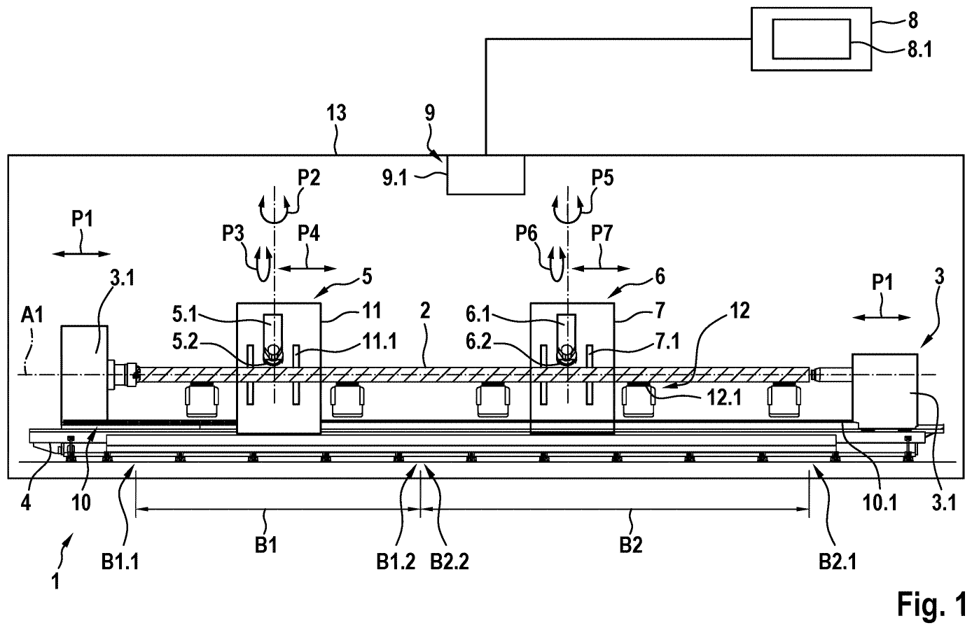

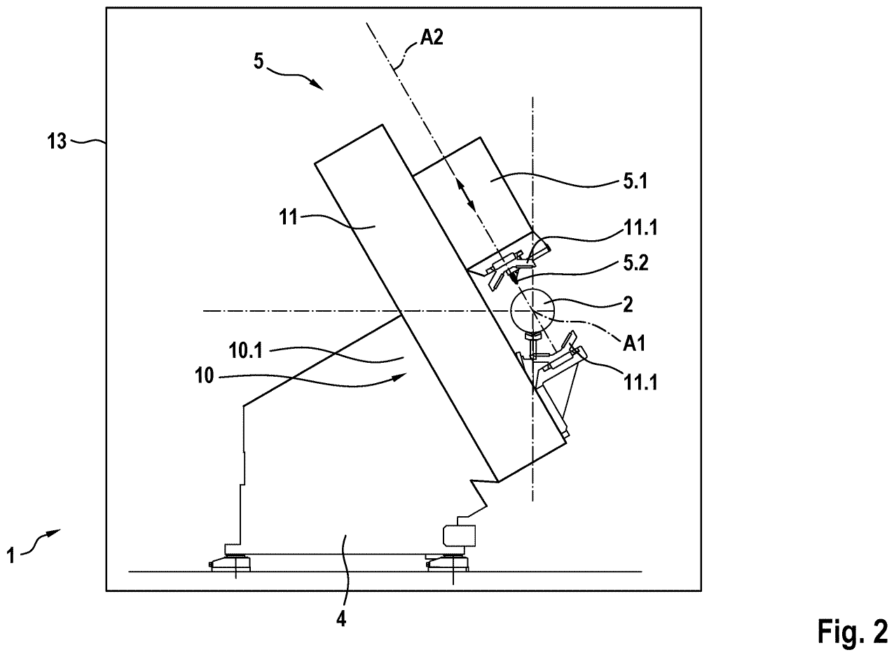

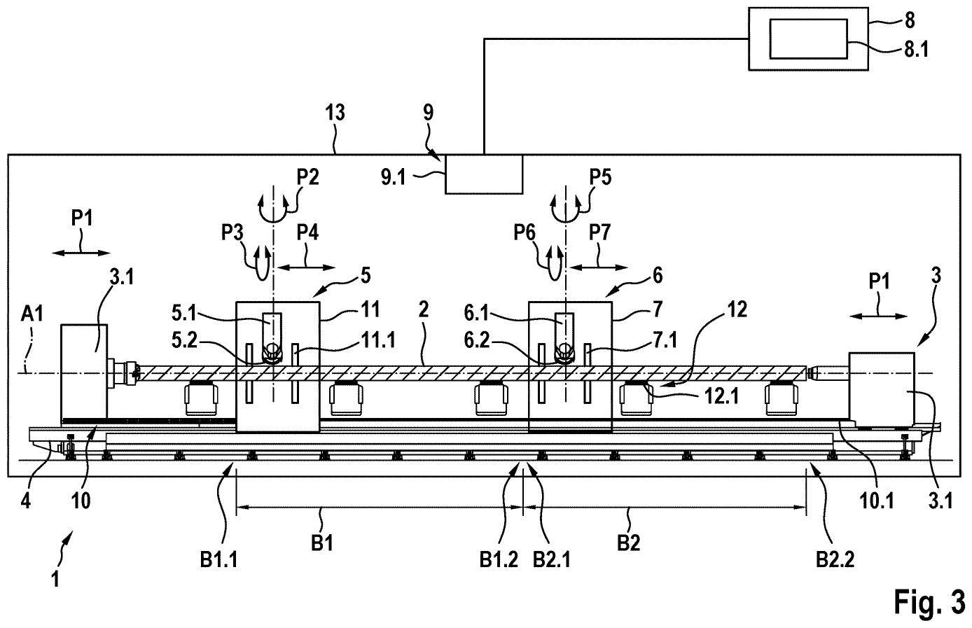

FIG. 1 shows a front view of a schematic representation of a machining center according to an embodiment.
FIG. 2 shows a view rotated 90° relative thereto of a schematic representation of a machining center according to an embodiment.
FIG. 3 shows a front view of a schematic representation of a machining center according to an embodiment.

The machining center 1 is configured for machining of an elongated metallic workpiece 2 with a cylindrical geometry or basic shape. The machining of the workpiece 2 that can be performed by means of the machining center 1 can be used in particular for the manufacture of a drive element, e.g., in the form of a rotor, in particular for a drill string. The machining center 1 can therefore be configured in particular for machining of a corresponding workpiece 2 for the purpose of manufacturing a drive element, e.g., in the form of a rotor, in particular for a drill string.

The machining center 1 comprises a mounting device 3 for mounting the workpiece 2. The mounting device 3 can be configured in particular for rotatably mounting the workpiece 2 about its longitudinal axis. For this purpose, the mounting device 3 may comprise one or more drives by means of which the supported workpiece 2 can be set in rotary motion about its longitudinal axis.

The mounting device 3 may be formed by one or more mounting units 3.1 or comprise one or more mounting units 3.1. In the embodiment, the mounting device 3 comprises a first mounting unit 3.1, which is configured for mounting a first section, in particular a first free end, of the workpiece 2, and a second mounting unit 3.1, which is configured for mounting a second section, in particular a second free end, of the workpiece 2. The respective mounting units 3.1 can, for example, be designed as clamping and/or tensioning units or comprise such units, which are configured for clamping or tensioning support of the workpiece 2, i.e., in particular, the respective first and second sections of the workpiece 2. Specific examples of corresponding mounting units 3.1 include, but are not limited to, chucks, tailstocks, etc.

As indicated by the double arrows P1, respective mounting units 3.1 can be mounted so that they can move relative to each other in a translational degree of freedom along a machining or machine axis A1 of the machining center 1, regardless of their specific design. The mounting device 3 can therefore be configured to bear workpieces 2 of different lengths, as at least one mounting unit 3.1 can be mounted so as to be movable relative to another mounting unit 3.1. The mounting device 3 can comprise one or more drives for this purpose, via which at least one mounting unit 3.1 can be moved in a movement along the machining or machine axis A1 relative to another mounting unit 3.1. Specifically, respective mounting units 3.1 can, for example, be movably arranged or formed on or in a machine bed 4 of the machining center 1.

The mounting device 3 can be configured to bear workpieces 2 with a length of more than 5 m, in particular more than 7.5 m, and more particularly more than 10 m. Accordingly, the machining center 1 can be configured to machine workpieces 2 with a length of more than 5 m, in particular more than 7.5 m, and in particular more than 10 m.

The machining center 1 further comprises a first milling unit 5 that is movable in at least one degree of freedom, which can in principle be a translational and/or a rotational degree of freedom, relative to the workpiece 2 stored by means of the mounting device 3. The first milling unit 5 typically comprises a housing structure 5.1, a milling tool 5.2 arranged on or in the housing structure 5.1 and rotatable about a tool axis A2 (see FIG. 2) arranged on or in the housing structure 5.1, and a drive associated with the milling tool 5.2, which is configured to generate a driving force that sets the milling tool 5.2 in rotational motion and to transmit this driving force to the milling tool 5.2. Specifically, the first milling unit 5 can be designed as a milling head, which comprises a corresponding housing structure 5.1 and at least one milling tool 5.2 arranged on or in the housing structure 5.1.

In connection with FIG. 2, it should be added that the first milling unit 5, as indicated by the double arrow, is typically also movable in a translational manner, e.g., along the axis A2, relative to the workpiece 2; the same typically applies to the second milling unit 6, which is therefore also mounted so as to be movable in such a translational degree of freedom.

The housing structure 5.1 of the first milling unit 5 can be arranged directly or indirectly on a support structure 11, e.g., of a slide-type, which can be moved translationally along the machining or machine axis A1. The support structure 11 can be configured, as indicated by the double arrows P2, P3, to mount the first milling unit 5 so that it can pivot in at least one degree of freedom of swivel movement around pivot axes oriented, for example, parallel or at right angles to the machining or machine axis A1, and can comprise one or more drives for this purpose. In particular, the degree of freedom of movement indicated by the double arrow P3 is optional. The support structure 11 may also comprise, as shown in FIG. 2, one or more support elements 11.1 which are configured to support the workpiece 2. At least one support element 11.1 can be moved relative to the workpiece 2 via one or more drives, e.g., radially with respect to the longitudinal axis of the workpiece 2, in order to support the workpiece 2 in the area of the support structure 11 and thus in the area of machining by the first milling unit 5. It is also conceivable that at least one corresponding support element 11.1 is arranged or formed on the housing structure 5.1 of the first milling unit 5 and either the housing structure 5.1 together with the at least one support element 11.1 or only the at least one support element 11. 1 is mounted movably relative to the housing structure 5.1 so that it can be moved against the workpiece 2 in order to support the workpiece 2 in the area of the support structure 11 and thus in the area of machining by the first milling unit 5.

In order to set the first milling unit 5 in motion relative to the workpiece 2 mounted by means of the mounting device 3, the machining center 1 comprises at least one drive assigned to the first milling unit 5, which is configured to generate a drive force that moves the first milling unit 5 in a movement relative to the workpiece 2 supported by the mounting device 3 and to transmit this drive force to the first milling unit 5. This movement of the first milling unit 5 is a translational movement along a translational axis, indicated by the double arrow P4, which may coincide with or be parallel to the machining or machine axis A1.

In the embodiment, in addition to the degree of translational freedom relative to the workpiece 2 supported by the mounting device 3, the first milling unit 5 is exemplarily movable in two degrees of freedom of swivel motion indicated by the double arrows P2, P3, with a degree of freedom of swivel movement around a pivot axis parallel to the machining or machine axis A1 and around a pivot axis perpendicular thereto. Consequently, in the embodiment, the first milling unit 5 can be movable in one degree of translational freedom and in two degrees of rotational freedom or in a degree of freedom of swivel movement relative to the workpiece 2 supported by the mounting device 3. In this way, complex milling tasks can be performed by means of the first milling unit 5, and complex geometries can thus be introduced into the workpiece 2.

The machining center 1 further comprises a second milling unit 6 that is movable in at least one degree of freedom, which can basically be a translational and/or a rotational degree of freedom, relative to the workpiece 2 supported by the mounting device 3. The second milling unit 6 typically comprises a housing structure 6.1, a milling tool 6 arranged on or in the housing structure 6.1 and rotatable about a tool axis, 2, and a drive arranged on or in the housing structure 6.1 and associated with the milling tool 6.2, which drive is configured to generate a driving force that sets the milling tool 6.2 in rotational motion and to transmit this driving force to the milling tool 6.2. Specifically, the second milling unit 6 can be designed as a milling head, which comprises a corresponding housing structure 6.1 and at least one milling tool 6.2 arranged on or in the housing structure 6.1.

The housing structure 6.1 of the second milling unit 6 can also be arranged directly or indirectly on a support structure 7, e.g., of a slide-type, which can be moved translationally along the machining or machine axis A1. As indicated by the double arrows P5, P6, the support structure 7 can be configured to support the second milling unit 6 in at least one degree of freedom of swivel movement around a swivel axis oriented, for example, parallel or at right angles to the machining or machine axis A1, and can comprise one or more drives for this purpose. In particular, the degree of freedom of movement indicated by the double arrow P6 is optional. The support structure 7 may also comprise one or more support elements 7.1 which are configured to support the workpiece 2. At least one support element 7.1 can be moved relative to the workpiece 2 via one or more drives, e.g., radially with respect to the longitudinal axis of the workpiece 2, in order to support the workpiece 2 in the area of the support structure 7 and thus in the area of machining by the second milling unit 6. It is also conceivable that at least one corresponding support element 7.1 is arranged or formed on the housing structure 6.1 of the second milling unit 6 and either the housing structure 6.1 together with the at least one support element 7.1 or only the at least one support element 7.1 is mounted movably relative to the housing structure 6.1 in order to be able to be moved against the workpiece 2 to support the workpiece 2 in the area of the support structure 7 and thus in the area of machining by the second milling unit 6.

In order to set the second milling unit 6 in movement relative to the workpiece 2 mounted by means of the mounting device 3, the machining center 1 comprises at least one drive assigned to the second milling unit 6, which is configured to generate a drive force that causes the second milling unit 6 to move in a movement relative to the workpiece 2 supported by the mounting device 3 and to transmit this drive force to the second milling unit 6. This movement of the second milling unit 6 is a translational movement along a translational axis, indicated by the double arrow P7, which may coincide with or be arranged parallel to the machining or machine axis A1.

In the embodiment, in addition to the degree of translational freedom relative to the workpiece 2 supported by the mounting device 3, the second milling unit 6 is exemplarily movable in two degrees of freedom of swivel motion indicated by the double arrows P5, P6, with a degree of freedom of swivel movement around a pivot axis parallel to the machining or machine axis A1 and around a pivot axis perpendicular thereto. Consequently, in the embodiment, the second milling unit 6 can be movable in one degree of translational freedom and in two degrees of rotational freedom or in a degree of freedom of swivel movement relative to the workpiece 2 supported by the mounting device 3. In this way, complex milling tasks can be performed by means of the second milling unit 6, and complex geometries can thus be introduced into the workpiece 2.

The embodiment shows that each milling unit 5, 6 can be mounted so that it can move both in one degree of translational freedom along the machining or machine axis A1 and in one or more degrees of freedom of swivel movement about a pivot axis parallel and/or perpendicular to the machining or machine axis A1. The translational movements and/or the swivel movements of the milling units 5, 6 are typically coordinated with or synchronized to a rotational movement of the workpiece 2 about its longitudinal axis.

The machining center 1 further comprises a hardware and/or software-implemented control device 8, which is used to control movements of the first milling unit 5 in the respective degree(s) of freedom of movement in or within a first machining area B1 assigned to the first milling unit 5 of a the workpiece 2 supported by the mounting device 3, and for controlling movements of the second milling unit 6 in the respective degree(s) of freedom of movement in or within a second machining area B2 assigned to the second milling unit 6 of the workpiece 2 supported by the mounting device 3, is configured. A respective machining area B1, B2 typically comprises at least one machining path determined by a starting point B1.1, B2.1 and an end point B1.1, B2.2, within which the respective milling unit 5, 6 moves or can move within the scope of machining the respective machining area B1, B2. A respective machining area B1, B2 typically corresponds to an area or subarea of the workpiece 2 which is to be machined by the machining center 1; respective machining areas B1, B2 thus typically, in common, represent the area of the workpiece 2 to be machined by the machining center 1.

Each milling unit 5, 6 is or will therefore typically be assigned at least one machining area B1, B2, which the respective milling unit 5, 6 has to machine; the workpiece 2 can therefore be machined, in particular simultaneously, in different areas—these correspond to the machining areas B1, B2 of the respective milling units 5, 6—by providing at least two milling units 5, 6, 6—which significantly increases the efficiency of the machining possible with the machining center 1 compared to machining centers with only one milling unit.

The control device 8 is typically also designed to define or generate respective machining areas B1, B2 and assign them to the milling units 5, 6. The control device 8 can therefore be configured to define a machining task for a workpiece 2 by generating or defining and assigning machining areas B1, B2 in the sense of machining job planning and, as will become apparent below, even to adapt it during operation of the machining center 1 if necessary. Specifically, the control device 8 can be configured to assign the first machining area B1 to the first milling unit 5 and the second machining area B2 to the second milling unit 6.

In this case, the control device 8 can take one or more input parameters into account; consequently, the control device 8 can be configured to generate respective machining areas B1, B2 on the basis of at least one input parameter and to assign them to the milling units 5, 6. Corresponding input parameters can be, for example, and thus not exclusively: geometric-constructive parameters, such as dimensions, geometry, etc., of the workpiece 2 to be machined, geometric-constructive parameters, such as dimensions, geometry, etc., of the machined workpiece 2, material parameters of the workpiece 2, such as hardness, machinability, etc., parameters of the milling units 5, 6, such as power consumption, or parameters of the milling tools 5.2, 6.2, such as type of milling tools 5.2, 6.2, geometry of the milling tools 5.2, 6.2, hardness of the milling tools 5.2, 6.2, etc.

The control of movements of the first milling unit 5 in or within the first machining area B1 assigned to it and the control of movements of the second milling unit 6 in or within the second machining area B2 assigned to it, which is possible by means of the control device 8, may also include the control of one or more operating parameters, such as the power consumption of the respective milling units 5, 6 for machining the workpiece 2 in the respective machining area B1, B2.

The control device 8 may be assigned a user interface 8.1 implemented in hardware and/or software, via which a user can make control-related inputs; in particular, it may be possible to make inputs via the user interface 8.1 make inputs regarding the planning and/or adaptation of machining jobs for a workpiece 2, on the basis of which the control device 8 determines a machining task for a workpiece 2 by correspondingly generating or defining and assigning machining areas B1, B2 in the sense of machining job planning and, if necessary, even adapts it during operation of the machining center 1.

The control device 8 can be configured in particular to control movements of the first milling unit 5 in the at least one degree of freedom of movement depending on or independently of movements of the second milling unit 6 in the at least one degree of freedom of movement, or vice versa. Consequently, movements of the first milling unit 5 in the at least one degree of freedom can be controlled depending on and thus taking into account movements of the second milling unit 6 in the at least one degree of freedom (or vice versa); in this way, it can be ensured, for example, that the milling units 5, 6 operate at a desired distance from each other in order to avoid situations in which the machining of a workpiece 2 by means of the first milling unit 5 in the first machining area B1 may have a negative effect on the machining of the workpiece 2 in the second machining area B2 (or vice versa). A variant that is easier to implement in terms of control technology may be one in which movements of the first milling unit 5 in the at least one degree of freedom are controlled independently of movements of the second milling unit 6 in the at least one degree of freedom, meaning that the respective milling units 5, 6 operate independently of each other within their respective machining areas B1, B2.

As mentioned, the control device 8 can be configured to assign the first machining area B1 to the first milling unit 5 and the second machining area B2 to the second milling unit 6. This can also include the control device 8 being configured to assign the machining, i.e., in particular, the complete machining of the first machining area B1 assigned to the first milling unit 5 by means of the first milling unit 5 and the machining, i.e., in particular, the complete machining of the second machining area B2 assigned to the second milling unit 6 by means of the second milling unit 6.

As also mentioned, a respective machining area B1, B2 typically comprises at least one machining path defined by a starting point B1.1, B2.1 and an end point B1.2, B2.2. A respective starting point B1.1, B2.1 or end point B1.2, B2.2 can, as shown in FIG. 1, be located at or in an edge area with respect to the longitudinal axis of the workpiece 2 or, as shown in FIG. 3, within the workpiece 2. Consequently, the machining of a workpiece 2 can be carried out, for example, with the first milling unit 5 starting from a first edge area of the workpiece 2, such as a first free end of the workpiece 2; the first milling unit 5 can therefore be moved, for example, starting from the edge area having the starting point B1.1 of the first machining area B1 in the direction of the end point B1.2 during the machining of the workpiece 2. The end point B1.2 of the first machining area B2 can therefore be offset in the direction of the second free end of the workpiece 2 (“machining from the outside to the inside”). However, a reverse procedure is also possible (“machining from the inside to the outside”). Similarly, the workpiece 2 can be machined with the second milling unit 6 starting from a second edge area of the workpiece 2, such as a second free end of the workpiece 2; the second milling unit 6 can therefore be moved, for example, starting from the edge area with the starting point B2.1 of the second machining area B2 in the direction of the end point B2.2 during the machining of workpiece 2. The end point B2.2 of the second machining area B2 can therefore be offset in the direction of the first free end of the workpiece 2 (“machining from the outside to the inside”). Here too, a reverse procedure (“machining from the inside to the outside”) is possible.

Alternatively or additionally, a starting point B1.1, B2.1 or end point B1.2, B2.2 of at least one machining area B1, B2 may be spaced apart from an edge area with respect to the longitudinal axis of the workpiece 2 or may be located within the workpiece 2. Consequently, variants are also conceivable in which a milling unit 5, 6 (only) machines the edge areas of a workpiece 2, e.g. in order to form certain interfaces in these, and another milling unit 5, 6 machines the remaining (inner) areas of the workpiece 2, e.g. in order to form a functional geometry in these that is necessary for the intended function of the machined workpiece 2.

In principle, the first and second machining areas B1, B2 can overlap each other at least in sections (axially with respect to the longitudinal axis of the workpiece 2) or they cannot overlap each other. In the first variant, the starting point B1.1 and/or end point B1.2 of the first machining area B1 can therefore lie within the second machining area B2 (or vice versa), resulting in an overlapping area in which machining of the workpiece 2 by both milling units 5, 6 is possible. This can be useful, for example, when an (unmachined) workpiece 2 is initially machined; meaning that initial machining of the workpiece 2 in an area that can be designated as the initial area can only be carried out by one milling unit 5, 6, whereupon the other milling unit 5, 6 begins its machining of the workpiece 2 at or in the area that was initially machined (initial area). The machining areas B1, B2 assigned to the respective milling units 5, 6 can therefore overlap at least in an area of workpiece 2 comprising a corresponding initial area. In the second variant, the starting point B1.1 and/or end point B1.2 of the first machining area B1 lies outside the second machining area B2 (or vice versa), so that no or fewer control-related measures, i.e., in particular safety-related measures, need to be provided in order, for example, prevent unwanted proximity or collision of the milling units 5, 6.

As indicated, the control device 8 can be configured to adjust or change the first and/or second machining area B1, B2. Consequently, the machining area B1, B2 (originally) assigned to a respective milling unit 5, 6 can be changed, i.e., in particular enlarged or reduced. The control device 8 can therefore also be configured to change the assignment of the first milling unit 5 to the first machining area B1, so that the first milling unit 5 can also be assigned or is assigned to the second machining area B2, at least in sections. Alternatively or in addition, the control device 8 can be configured to change the assignment of the second milling unit 6 to the second machining area B2, so that the second milling unit 6 can also be assigned or is assigned to the first machining area B1, at least in sections.

The adjustment or change of a respective machining area B1, B2 can be carried out dynamically in particular. The adjustment or modification of a respective machining area B1, B2 can be carried out in particular during the machining of a workpiece 2, i.e. during the operation of the milling units 5, 6, and opens up a high degree of flexibility in connection with the machining of a workpiece 2, for example because it is possible for a milling unit 5, 6 can (also) work in at least one of these areas of the workpiece 2 that were not originally assigned. In this way, for example, machining delays of the other milling unit 5, 6 can be considered. The possibility of adjusting the first and/or second machining area B1, B2 can therefore also have a positive effect on the efficiency of the machining center 1.

The machining center 1 may comprise a monitoring device 9 which is configured to monitor the operation of the first and/or second milling unit 5, 6 and to generate monitoring information describing the operation of the first and/or second milling unit 5, 6. Monitoring the operation of the first and/or second milling unit 5, 6 may also include monitoring the machining result and/or progress of the respective milling unit 5, 6 and generating information describing the respective machining result and/or machining progress; this information may be included in the monitoring information.

The monitoring device 9 may, for example, be designed as an optical monitoring device, such as an image or video recording device 9.1, or at least comprise such a device. Alternatively or additionally, differently configured monitoring devices, such as acoustic monitoring devices, are also conceivable, since information about the operation of the first and/or second milling unit 5, 6 can also be derived from monitored acoustic signals.

The control device 8 may be configured to adjust or change a respective machining area B1, B2 and/or the assignment of respective machining areas B1, B2 on the basis of the monitoring information. Consequently, an adjustment or change of respective machining areas B1, B2 can be made considering the operation of respective milling units 5, 6 or the machining result and/or progress of respective milling units 5, 6, which can lead to highly efficient machining of a workpiece 2.

As mentioned, the milling units 5, 6 in the embodiments are movable in a translational degree of freedom relative to the workpiece 2, among other things. The movement of the respective milling units 5, 6 in the translational degree of freedom relative to the workpiece 2 can be realized by means of at least one guide device 10 (see in particular FIG. 2), in particular at least one linear guide device. The at least one guide device 10 can extend along the machining or machine axis A1. The at least one guide device 10 may comprise one or more guide elements 10.1, in particular linear guide elements, such as guide rails, which are configured to interact with the respective milling unit 5, 6 to form a translationally movable guide. In particular, corresponding guide elements 10.1 may be configured to interact with a corresponding counter-guide element on the part of a respective milling unit 5, 6, e.g., mechanically, i.e., in particular, in a form-fitting and/or force-fitting manner. If a milling unit 5, 6 is arranged on one of these associated support structures 11, 7, e.g. of a slide-type, as described above, corresponding guide elements 10.1 may be configured to interact with a corresponding counter-guide element of a respective support structure 11, 7, e.g. mechanically, i.e. in particular in a form-fit and/or force-fit manner.

The embodiments show, by way of example, that the first milling unit 5 and the second milling unit 6 can be guided common via a common guide device 10, which can simplify the design of the machining center 1, as only one (single) guide device 10 is required. Alternatively, it is conceivable that each milling unit 5, 6 is guided by its own guide device 10.

The machining center 1 may further comprise a support device 12 which is configured to support a workpiece 2 to be machined by means of the machining center 1 at one or more support points along the longitudinal axis of the workpiece 2. In this way, undesirable sagging of the workpiece 2 can be avoided or at least reduced, which could otherwise have a negative effect on the machining of the workpiece 2 by the milling units 5, 6. In the embodiments, the support device 12 comprises several support elements 12.1, each of which can be movably mounted between at least one operating position, in which a workpiece 2 can be supported at a support point, and at least one non-operating position, in which support of a workpiece 2 at one or more support points is not possible.

In all embodiments, the first milling unit 5 and the second milling unit 6 can be identical in design; this ensures that milling tasks that are (or can be) performed with the first milling unit 5 do not differ from milling tasks that are (or can be) performed with the second milling unit 6 (and vice versa). However, it is also conceivable that the first and second milling units 5, 6 are not identical, so that milling tasks that are (or can be) performed with the first milling unit 5 differ from milling tasks that are (or can be) performed with the second milling unit 6 (and vice versa). For example, the first milling unit 5 may enable machining with a geometrically undefined cutting edge and the second milling unit 6 may enable machining with a geometrically defined cutting edge. More specifically, the first milling unit 5 can, for example, enable rough machining of the workpiece, and the second milling unit 6 can enable, for example, finish machining rather than rough machining.

Furthermore, for all embodiments, individual, several, or all of the aforementioned functional units of the machining center 1, i.e., in particular the mounting device 3 with the respective mounting units 3.1 (if present), the milling units 5, 6, the monitoring device 9 (if present), the guide device 10 (if present), the support device 12 (if present), can be arranged or formed in a machine housing 13 of the machining center 1, which forms a superordinate housing structure. The aforementioned machine bed 4 can also be arranged or formed in the machine housing 13 of the machining center 1.

The machining centers 1 shown in the embodiments can be used to implement a method for machining an elongated metallic workpiece 2, in particular for manufacturing a drive element, in particular for a drill string. The method comprises in particular the following steps: Supporting an elongated metallic workpiece 2 to be machined by means of the machining center 1, Moving a first milling unit 5 in at least one degree of freedom relative to the supported workpiece 2, wherein the workpiece 2 is machined with the first milling unit 5 in at least one first machining area B1 assigned to the first milling unit 5, moving a second milling unit 6 in at least one degree of freedom relative to the stored workpiece 2, wherein the workpiece 2 is machined with the second milling unit 6 at least in a second machining area B2 assigned to the second milling unit 6. The method further comprises the steps of: controlling movements of the first milling unit 5 in the at least one degree of freedom of movement in or within the first machining area B1 assigned to the first milling unit 5, and controlling movements of the second milling unit 6 in the at least one degree of freedom of movement in or within the second machining area B2 assigned to the second milling unit 6.

Individual, several, or all of the features described in connection with one embodiment may be combined with individual, several, or all of the features described in connection with at least one other embodiment.

1. A machining center for machining an elongated metallic workpiece, comprising:
a mounting device for mounting the elongated metallic workpiece to be machined,
a first milling unit movable in at least one degree of freedom relative to a workpiece mounted by means of the mounting device,
a second milling unit movable in at least one degree of freedom relative to a workpiece mounted by means of the mounting device,
a control device which is configured to control movements of the first milling unit in the at least one degree of freedom of movement in or within a first machining area of the workpiece assigned to the first milling unit, and
to control movements of the second milling unit in the at least one degree of freedom of movement in or within a second machining area of the workpiece assigned to the second milling unit.

2. The machining center according to claim 1, wherein the control device is configured to control movements of the first milling unit in the at least one degree of freedom of movement depending on or independently of movements of the second milling unit in the at least one degree of freedom of movement, or vice versa.

3. The machining center according to claim 1, wherein the control device is configured to assign the first machining area of the workpiece to the first milling unit and to assign the second machining area of the workpiece to the second milling unit.

4. The machining center according to claim 1, wherein a respective machining area comprises a machining path defined by a starting point and an end point, wherein a respective starting point or end point is located at an edge area with respect to a longitudinal axis of the workpiece or within the workpiece.

5. The machining center according to claim 1, wherein the first and second machining areas overlap or do not overlap each other at least in sections.

6. The machining center according to claim 1, wherein the control device is configured to change the first and/or second machining areas.

7. The machining center according to claim 1, wherein the control device is configured to change the assignment of the first milling unit to the first machining area so that the first milling unit can also be assigned or is assigned at least in sections to the second machining area, and/or the control device is configured to change the assignment of the second milling unit to the second machining area so that the second milling unit can also be assigned or is assigned to the first machining area at least in sections.

8. The machining center according to claim 1, comprising a monitoring device for monitoring an operation of the first and/or second milling unit and for generating corresponding monitoring information.

9. The machining center according to claim 8, wherein the control device is configured to change a respective machining area and/or the assignment based on the monitoring information.

10. The machining center according to claim 1, wherein the first milling unit and the second milling unit are mounted so as to be movable via a common or different guide devices.

11. The machining center according to claim 1, wherein the mounting device is configured to mount a workpiece to be machined by means of the machining center so that it can rotate about its longitudinal axis.

12. The machining center according to claim 1, comprising a support device for supporting a workpiece to be machined by means of the machining center at one or more support points along a longitudinal axis.

13. The machining center according to claim 1, wherein the first and/or second milling unit is mounted with a degree of translational and/or rotational freedom relative to the workpiece supported by a support device.

14. The machining center according to claim 1, wherein the first milling unit is mounted so as to be movable not only in a translational degree of freedom relative to a workpiece mounted by means of the mounting device along a translational axis, but also in at least one further degree of freedom relative to a workpiece mounted by means of the mounting device.

15. The machining center according to claim 1, wherein a housing structure of the first and/or second milling unit is arranged on a support structure, which is movable in a translational manner along the machining or machine axis of the machining center.

16. The machining center according to claim 15, wherein the support structure is configured to support the first and/or second milling unit in at least one degree of freedom of swivel movement around a swivel axis oriented, for example, parallel or at right angles to the machining or machine axis of the machining center.

17. The machining center according to claim 15, wherein the support structure comprises one or more support elements which are configured to support a workpiece.

18. The machining center according to claim 17, wherein at least one support element is moved against the workpiece via one or more drives, e.g., radially with respect to the longitudinal axis of the workpiece, in order to support the workpiece in the area of the support structure, or wherein at least one support element is arranged or formed on the housing structure of the first milling unit and either the housing structure together with the at least one support element or only the at least one support element is mounted movably relative to the housing structure.

19. A method for machining an elongated metallic workpiece, comprising:
mounting an elongated metallic workpiece to be machined by means of a machining center,
moving a first milling unit in at least one degree of freedom relative to the mounted workpiece, wherein the workpiece is machined with the first milling unit in at least one first machining area assigned to the first milling unit,
moving a second milling unit in at least one degree of freedom relative to the supported workpiece, wherein the workpiece is machined with the second milling unit at least in a second machining area assigned to the second milling unit,
controlling movements of the first milling unit in the at least one degree of freedom in the or within the first machining area of the workpiece assigned to the first milling unit, and
controlling movements of the second milling unit in the at least one degree of freedom in the or within the second machining area of the workpiece assigned to the second milling unit.

20. The method according to claim 19, wherein it is performed with a machining center for machining the elongated metallic workpiece, wherein the machining center comprises:
a mounting device for mounting the elongated metallic workpiece to be machined.
the first milling unit movable in at least one degree of freedom relative to the workpiece mounted by means of the mounting device,
the second milling unit movable in at least one degree of freedom relative to the workpiece mounted by means of the mounting device,
a control device which is configured to control movements of the first milling unit in the at least one degree of freedom of movement in or within the first machining area of the workpiece assigned to the first milling unit, and
to control movements of the second milling unit in the at least one degree of freedom of movement in or within the second machining area of the workpiece assigned to the second milling unit.
